(19) United States
(12) Patent Application Publication
(10) Pub. No.: US 2010/0281046 A1
(43) Pub. Date: Nov. 4, 2010

(54) Method and web server of processing a dynamic picture for searching purpose

(75) Inventor: Hong-Lin LEE, San Jose, CA (US)

Correspondence Address: BACON & THOMAS, PLLC, 625 SLATERS LANE, FOURTH FLOOR, ALEXANDRIA, VA, 22314-1176, US

(73) Assignee: DVtoDP Corp., San Jose, CA (US)

(21) Appl. No.: 12/457,308

(22) Filed: Jun. 8, 2009

(30) Foreign Application Priority Data
Apr. 30, 2009 (TW) 098114476

(51) Int. Cl. G06F 17/30; G06F 3/048; G06F 15/16

(52) U.S. Cl. 707/769; 715/780; 709/217; 707/E17.017; 707/803

(57) ABSTRACT

A method of processing dynamic pictures for searching purposes allows a user using a web server or PC to extract multiple still pictures from a dynamic picture. A user can input text information for at least one still picture. The text information can be used as search information so that a specific section of the dynamic picture can be found during a search for the dynamic picture.

### BACKGROUND OF THE INVENTION

1. Field of the Invention

The present invention relates to a method of processing a dynamic picture for searching purposes.

2. Description of the Related Art

Dynamic pictures, such as movies, short films, music videos, animated films, etc., are very popular in modern life. The high traffic volume on YouTube.com shows how much people enjoy dynamic pictures; however, the dynamic picture can only be searched for by its filename, or a special keyword added by a user.

Dynamic pictures can contain various content and are not as easy to describe as still pictures; therefore, search engines such as Google, Yahoo, and MSN can only do searches for picture (such as “picture” or “photo”) when provided a the keyword.

In order to search for dynamic pictures, some keywords need to be added to the dynamic picture. However, this method is not very helpful. Taking the famous movie “Arctic Tale” (http: //www.arctictalemovie.com) as an example; some keywords can be added, such as polar bear, iceberg, seal, whale, white fox, Nanu (the name of the little polar bear), environmental protection, sad, pitiful, tear, global warming, etc.; wherein the keywords polar bear, iceberg, seal, whale, white fox, Nanu describe the objects that appear in the movie, and the keywords environmental protection, and global warming describe the subject of the movie. Furthermore, the most touching portion of this movie is the scene in which Nanu is standing all alone on a little iceberg (due to global warming) alone, despairing”. Therefore, some viewers may want to input the keywords sad, touching, pitiful, and tear to describe the special feeling.

If the user wants to find the dynamic pictures for “white fox,” the user needs to type in the keywords “white fox” to find the movie “Arctic Tale.” The user needs to spend additional time to find scenes with a white fox in the movie “Arctic Tale.” Therefore, it is not convenient to apply that method in searching for dynamic pictures.

In order to improve this problem, U.S. patent publication No. 20040047589, entitled “Method for creating caption-based search information of moving picture data, searching and repeating playback of moving picture data based on said search information, and reproduction apparatus using said method”, discloses a method for performing a caption-based search to find the corresponding images. For example, when the user is watching “Arctic Tale”, the user can type “white fox” to search for “white fox” dynamic pictures, because the “Arctic Tale” movie has the words “white fox” in its caption.

However, the method disclosed in the patent publication requires caption data to be provided separate from the dynamic picture, such as a typical DVD format. But normal short videos that people usually upload to a web server (such as YouTube.com) do not have separate caption data. Therefore, this patent publication is not executable for internet video search.

Patent publication No. 20040047589 can only search for the text contained in the caption; for example, it is difficult to find the scene in which Nanu is standing all alone on the iceberg because that part has no special captions.

Furthermore, many contents of a dynamic picture cannot be described by captions. The emotional feeling evoked in the viewers is often very important, such as when Nanu is standing all alone on a little iceberg or Nanu is crawling out of the snow cave in the spring. In general, people may find one or three or five most memorable scenes or images in a dynamic picture; however, so far, there is no technology that can provide a fast search method for the users.

Therefore, it is desirable to provide a system and method to mitigate and/or obviate the aforementioned problems.

### SUMMARY OF THE INVENTION

A main objective of the present invention is to provide a method of processing a dynamic picture that enables searching.

Another objective of the present invention is to provide a friendly operating interface so that the user can process the dynamic pictures. Taking “Arctic Tale” as an example, the method of the present invention can help the user to find the picture of Nanu standing all alone on the iceberg.

Another objective of the present invention is to establish a web server so that the user can use the web server to process the dynamic picture and searching for the dynamic picture, and so that each user can share the processed dynamic picture with other users.

In order to achieve the above-mentioned objectives, the present invention provides a method of processing a dynamic picture enabling a user to use a web server or computer to perform a process with a dynamic picture to allow searches for it, the method comprising:
receiving an extraction command for the dynamic picture;
generating a plurality of still pictures according to the extraction command, wherein the plurality of still pictures are extracted from the dynamic picture;
receiving text information input by the user; wherein the text information corresponds to one of the plurality of still pictures; and
establishing a dynamic picture database, wherein the dynamic picture database corresponds to the dynamic picture, the dynamic picture database comprising records for:
   the plurality of still pictures;
   time stamps of each still picture appearing in the dynamic picture; and
   the text information;
whereby the user is able to input a keyword for a matching still picture by comparing the keyword with the still pictures stored in the dynamic picture database.

In one embodiment, in order to provide greater convenience for the user, an operating interface is provided, and the operating interface comprises a dynamic picture playing region, a still picture displaying region, and a text information input region.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the present invention.

FIG. 2 is a flowchart of processing a dynamic picture according to the present invention.

FIG. 3 is an embodiment of an operation interface according to the present invention.

FIG. 4 is an embodiment of the operation interface showing a plurality of still pictures extracted according to the present invention.

FIG. 5 is an embodiment of the operation interface showing text information input according to the present invention.

FIG. 6 is an embodiment of the operation interface showing a screen displaying the plurality of still pictures according to the present invention.

FIG. 7 is an embodiment of a dynamic pictures database according to the present invention.

FIG. 8 is a flowchart of a search for a dynamic picture according to the present invention.

FIG. 9 is a schematic drawing of an embodiment of a search interface according to the present invention.

FIG. 10 shows the search interface embodiment displaying the matched dynamic pictures according to the present invention.

FIG. 11 shows the operating interface after the search is performed and the keywords are displayed according to the present invention.

### DETAILED DESCRIPTION OF THE PREFERRED EMBODIMENT

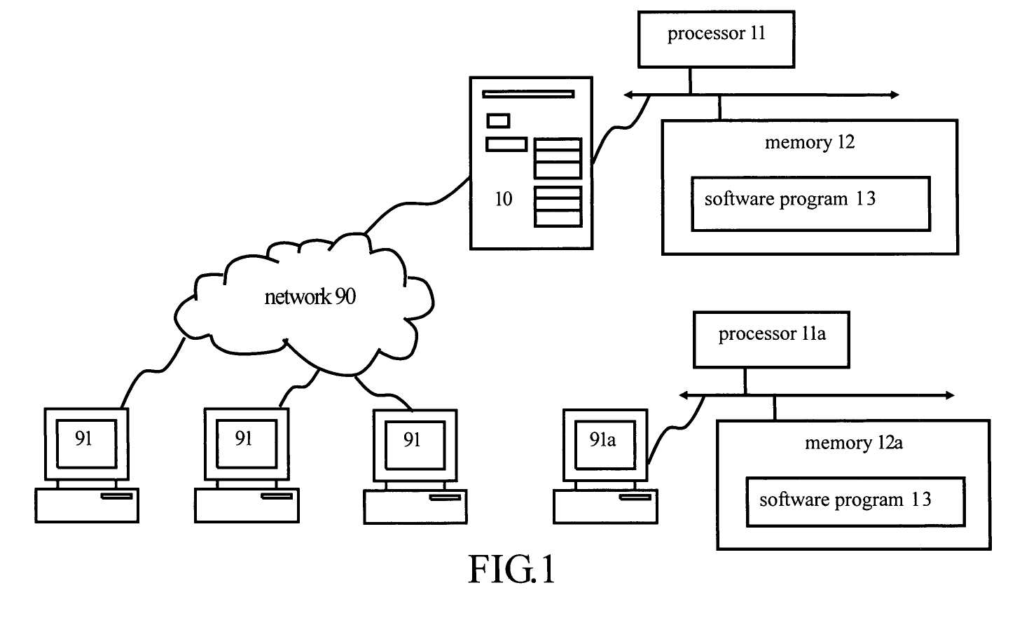

Please refer to FIG. 1. FIG. 1 is a schematic drawing of the present invention. A web server 10 is used for enabling a plurality of users to connect to a network 90 via a personal computer (PC) 91 to perform processing of and searching for dynamic pictures. The web server 10 comprises a processor 11 and a memory 12 which stores a software program 13. The processor 11 executes the software program 13 to process and search for the dynamic picture. Alternatively, the software program 13 can also be installed in the memory 12a of the PC 91a, and the processor 11a executes the software program 13 to enable the user to use the PC 91a to process and search for the dynamic picture.

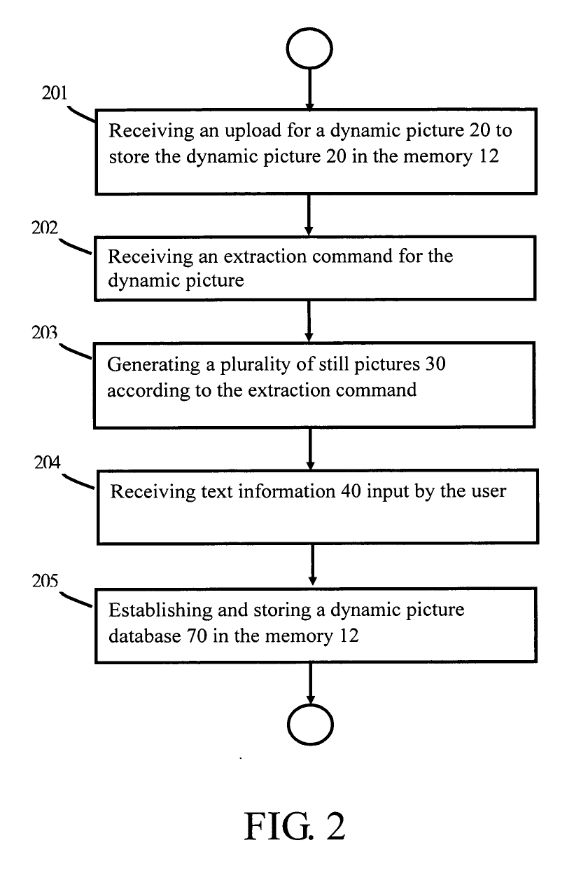

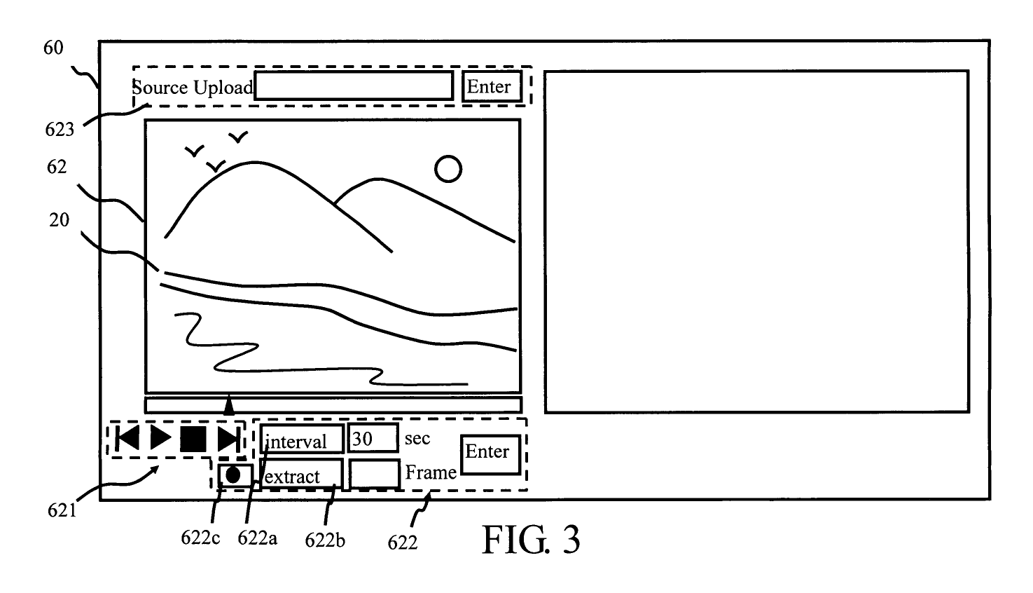

Please refer to FIG. 2. FIG. 2 is a flowchart of processing a dynamic picture according to the present invention. Please also refer to FIGS. 3-7.

### Step 201:

Receiving an upload of a dynamic picture 20 to store the dynamic picture 20 in the memory 12.

As shown in FIG. 3, the operating interface 60 first displays the left half. The operating interface 60 comprises a dynamic picture playing region 62 and a play control button 621, an extracting command input region 622, and a dynamic picture upload operation region 623.

The user uses the dynamic picture upload operation region 623 to upload the dynamic picture 20 stored in the PC 91 onto the web server 10 (usually with a file path and a filename). The web server 10 receives the dynamic picture 20, stores the dynamic picture 20 in the memory 12, and displays it in the dynamic picture playing region 62. The dynamic picture playing region 62 includes the play control button 621 in its lower section, and the user uses the play control button 621 to control the playback of the dynamic picture 20.

### Step 202:

Receiving an extraction command for the dynamic picture.

The dynamic picture playing region 62 includes the extracting command input region 622 in its lower section, and the extracting command input region 622 is used for enabling the user to select the method for extracting still pictures from the dynamic picture 20.

As shown in FIGS. 3˜5, there are three different extraction methods. The first method 622a is to perform the extraction with a predetermined time interval; for example, for a 10-minute video, if the predetermined time interval is 30 seconds for extracting each still picture, 20still pictures will be extracted. The second method 622b is to extract the pictures according to a number of images set by the user; for example, the software program 13 automatically calculates the time intervals for extraction or performs random extractions. The third method is to extract images at times chosen by the user with a capturing function 622c; when the dynamic picture 20 is playing, the user can click the capturing function 622c anytime. Since the extraction methods are well known technologies, there will be no further description.

### Step 203:

Generating a plurality of still pictures 30 according to the extraction command, wherein the plurality of still pictures 30 are extracted from the dynamic picture 20.

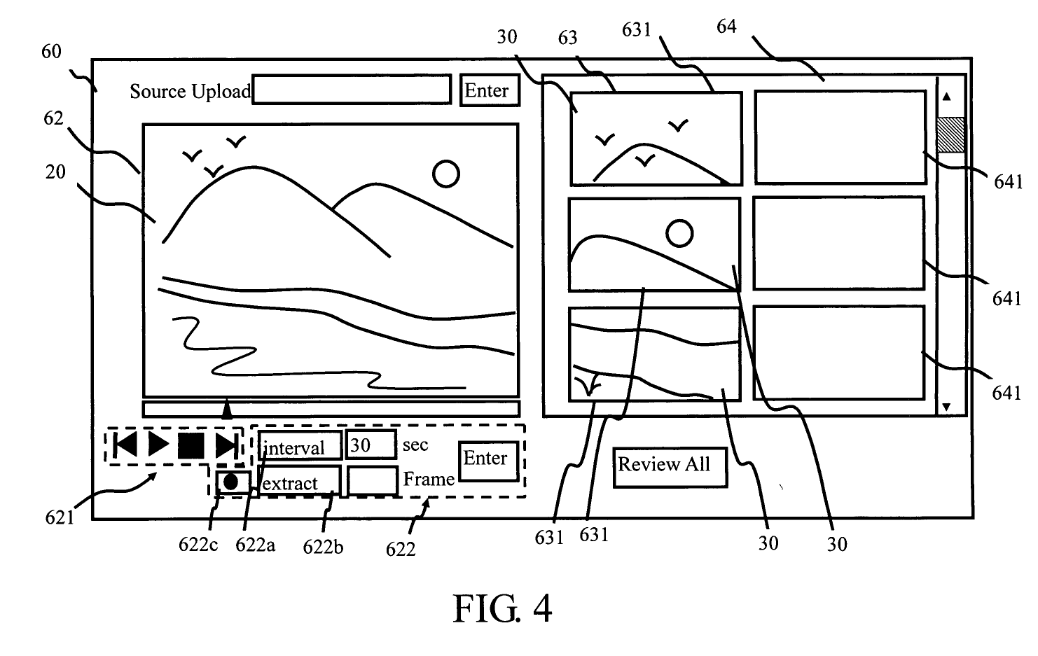

Please refer to FIG. 4. If step 202 is the performance of the extraction every 30 seconds, then every 30 seconds, a still picture 30 is generated in a still picture displaying region 63 at the right side of the operating interface 60. The still picture displaying region 63 comprises a plurality of first rectangular regions 631; each first rectangular region 631 is used for displaying one corresponding still picture 30, and the plurality of still pictures 30 is arranged in chronological order.

Furthermore, the operating interface 60 has a text information displaying region 64 in the right section. The text information displaying region 64 comprises a plurality of second rectangular regions 641; each second rectangular region 641 is arranged in pair with each corresponding first rectangular region 631. In addition, the rectangular regions 631,641 can be defined with or without a frame.

### Step 204:

Receiving text information 40 input by the user, wherein the text information 40 corresponds to one of the plurality of still pictures 30.

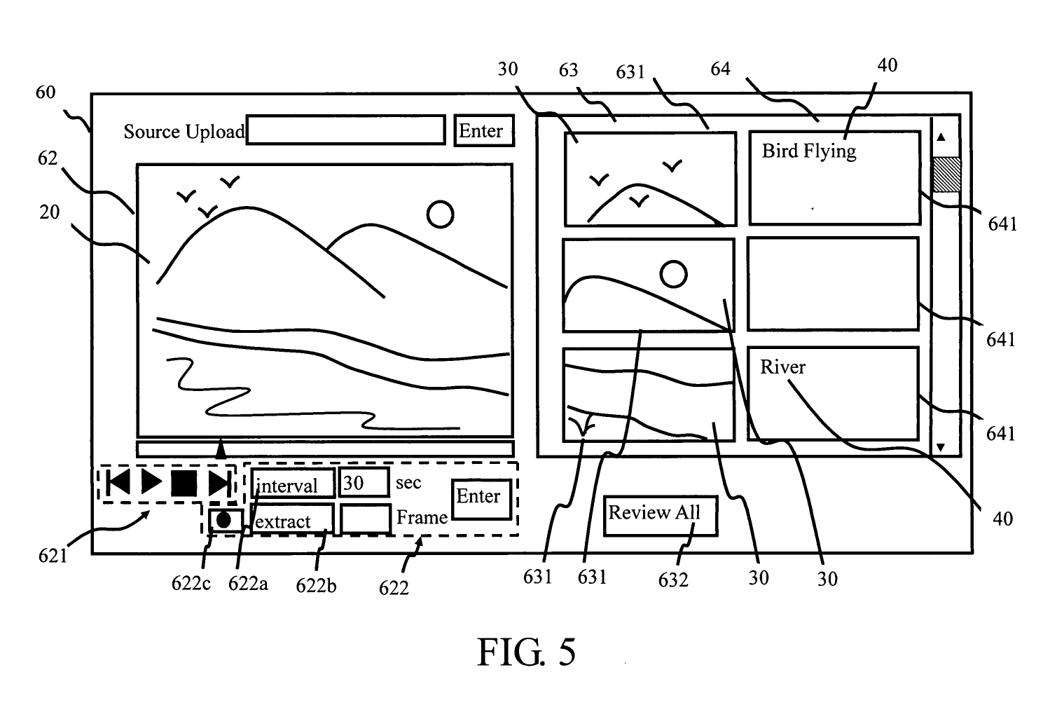

When the user sees the plurality of still pictures 30, he or she can input text information 40 (such as comments, keywords, or thoughts) in the second rectangular region 641 for the corresponding still pictures 30; for example, in FIG. 5, two corresponding second rectangular regions 641 for two still pictures 30 are inputted with texts “Bird Flying” and “River”.

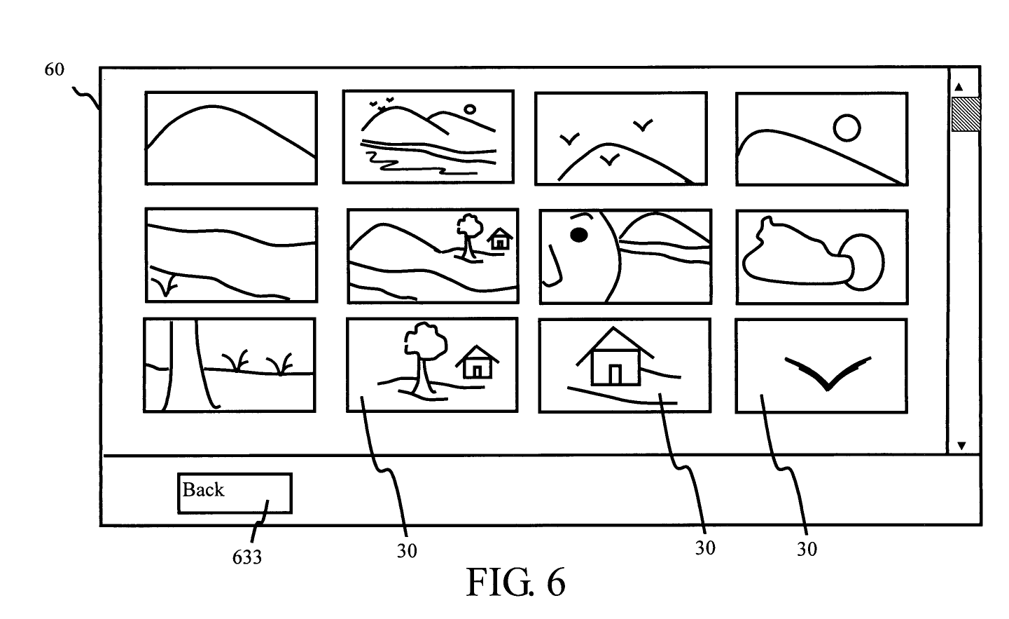

If the user wants to see only still picture 30, he or she can click on the “Review All” button 632, as shown in FIG. 6, and more still pictures 30 can be viewed. If the user wants to return to the previous picture, he or she can click the “Back” button 633.

### Step 205:

Establishing and storing a dynamic picture database 70 in the memory 12, wherein the dynamic picture database 70 corresponds to the dynamic picture 20.

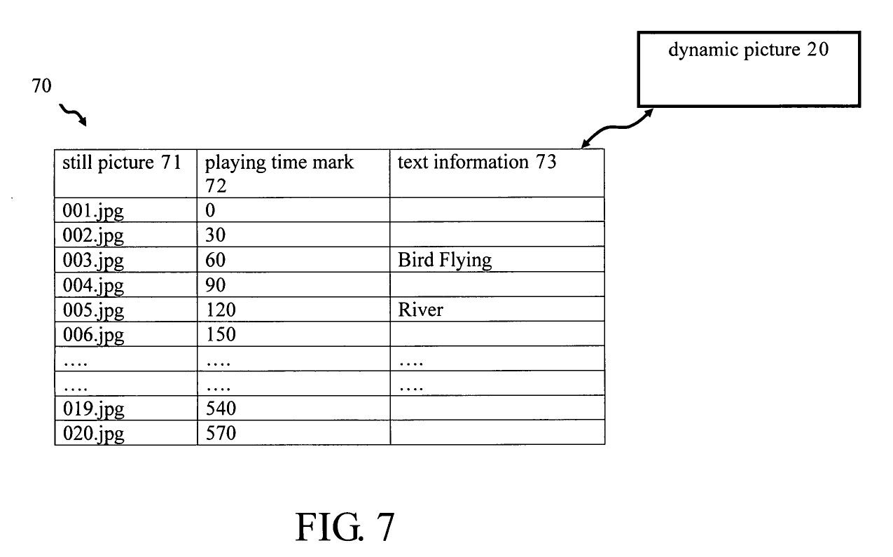

Each processed dynamic picture 20 (after still pictures are extracted or the text information 40 is input) establishes a dynamic picture database 70. Please refer to FIG. 7. The dynamic picture database 70 comprises a still picture column 71, a playing time stamp column 72, and a text information column 73. The still picture column 71 records the filename or index for each still picture. The playing time stamp column 72 records the time stamp at which the still picture 30 appears in the dynamic picture 20, and the text information column 73 records the text information 40 inputted for each still picture 30 in step 204.

The appearance times of each still picture 30 in the dynamic picture 20 are generated in step 203. The operating interface 60 can be designed to enable the user to select one of the still pictures 30, and the dynamic picture 20 is played from the time the still picture 30 appears such that each still picture 30 can be used as a bookmark. Moreover, the plurality of still pictures 30 can be used as bookmarks, which is one of the effects of the present invention.

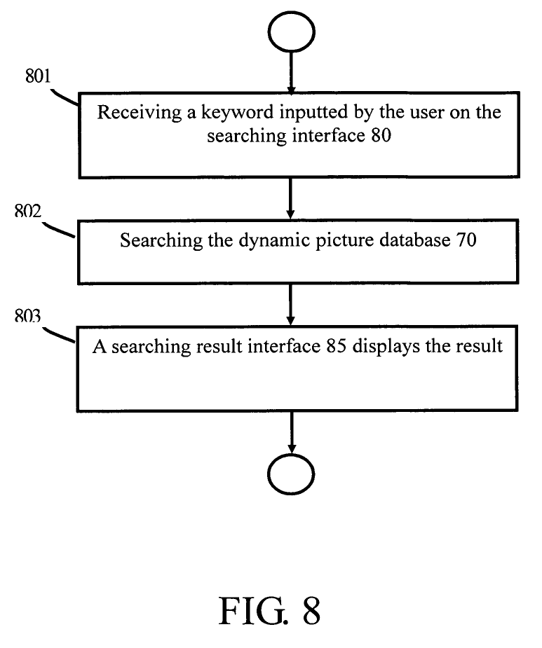

The plurality of users can establish a large number of dynamic pictures 20 and the dynamic picture database 70 corresponding to each dynamic picture 20 via the web server 10. Since the dynamic picture database 70 records the text information 40 inputted by the user, the search process can be performed to locate the dynamic picture 20. Please refer to FIGS. 8˜10 for the search process.

### Step 801:

Receiving a keyword inputted by the user on the search interface 80, such as a keyword “Bird”.

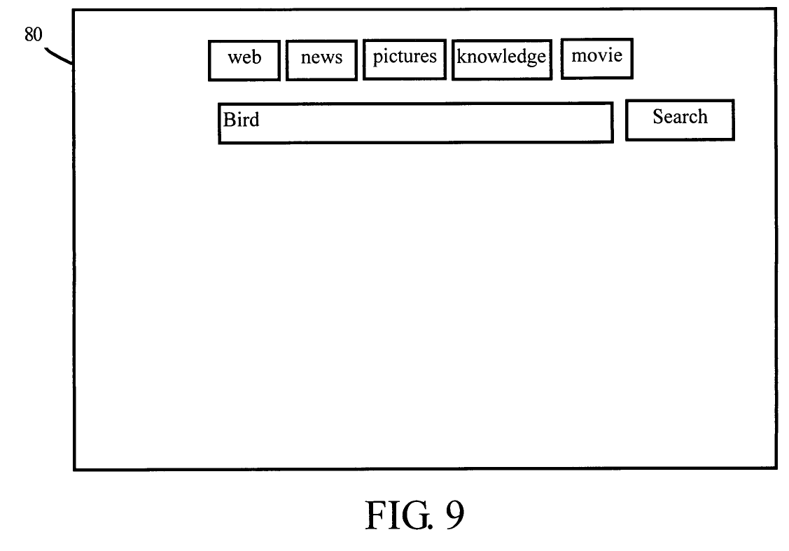

The search interface 80, as shown in FIG. 9, is a typical search interface having a text entry field 81. In FIG. 9, different databases such as typical “web pages”, “news”, “pictures” and “knowledge”, are provided above the text entry field 81; the search for dynamic pictures can be added onto the search interface, and a “video” option can be added above the text entry field 81.

### Step 802:

Searching the dynamic picture database 70; for example, searching for the keyword “Bird” in the dynamic picture database 70.

### Step 803:

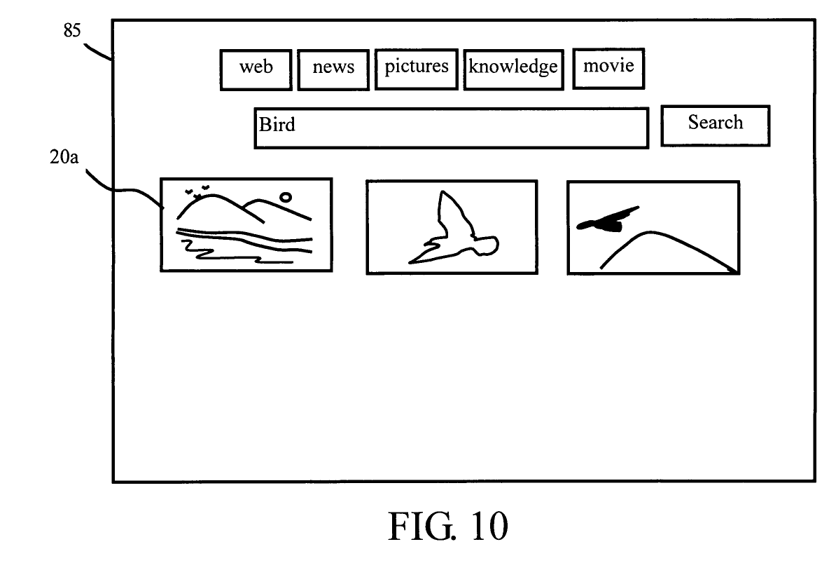

A search result interface 85 displays the result. As shown in FIG. 10, the text information in three dynamic picture databases 70 corresponding to the dynamic picture contains the keyword “Bird”.

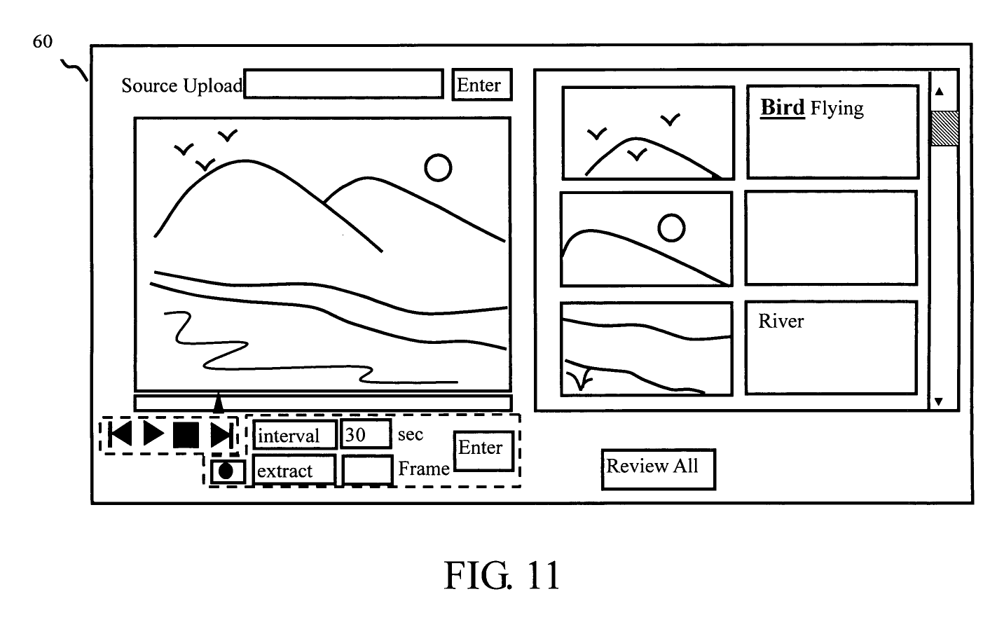

For example, the user selects the dynamic picture 20a and enters the operating interface 60, as shown in FIG. 11, and the keyword “Bird” can be highlighted (such as with different colors, or in a bold or italic font) to attract attention.

Although the present invention has been explained in relation to its preferred embodiment, it is to be understood that many other possible modifications and variations can be made without departing from the spirit and scope of the invention as hereinafter claimed.

What is claimed is:

1. A method of processing a dynamic picture enabling a user to use a web server or computer to perform a process with a dynamic picture for searching purposes, the method comprising:
receiving an extraction command for the dynamic picture;
generating a plurality of still pictures according to the extraction command, wherein the plurality of still pictures is extracted from the dynamic picture;
receiving text information input by the user; wherein the text information corresponds to one of the plurality of still pictures; and
establishing a dynamic picture database, wherein the dynamic picture database corresponds to the dynamic picture, the dynamic picture database comprising records for:
the plurality of still pictures;
time stamps of each still picture appearing in the dynamic picture; and
the text information;
whereby the user is able to input a keyword for searching for a matching still picture by comparing the keyword with the dynamic picture database.

2. The method as claimed in claim 1 further comprising:
providing an operating interface, the operating interface comprising:
a dynamic picture playing region for playing the dynamic picture;
a still picture displaying region for displaying the plurality of still pictures; and
a text information inputting region for the user to input the text information.

3. The method as claimed in claim 2, wherein the still picture displaying region comprises a plurality of first rectangular regions, and each first rectangular region is used for displaying one still picture; and
the text information displaying region comprises a plurality of second rectangular regions, the second rectangular regions being used for displaying the text information corresponding to each still picture.

4. The method as claimed in claim 3, wherein each first rectangular region and its corresponding second rectangular region are arranged next to each other, side by side.

5. The method as claimed in claim 4, wherein when one of the still pictures is selected, the dynamic picture is played, wherein the dynamic picture is played from the time stamp at which the selected still picture appears in the dynamic picture.

6. A web server for enabling a plurality of users to process and search for dynamic pictures through a network, the web server having a processor and a memory, the memory storing a software program, the processor executing the software program to perform the following steps:
receiving an upload of a dynamic picture to store the dynamic picture in the memory;
receiving an extraction command for the dynamic picture;
generating a plurality of still pictures according to the extraction command, wherein the plurality of still pictures are extracted from the dynamic picture;
receiving text information input by the user, wherein the text information corresponds to one of the plurality of still pictures;
establishing and storing a dynamic picture database in the memory, wherein the dynamic picture database corresponds to the dynamic picture, the dynamic picture database comprising records for:
the plurality of still pictures;
time stamps of each still picture appearing in the dynamic picture; and
the text information;
whereby the user is able to input a keyword for searching for a matching still picture by comparing the keyword with the dynamic picture database.

7. The web server as claimed in claim 6, wherein the processor executes the software program to further perform the step of providing an operating interface, the operating interface comprising:
a dynamic picture playing region for playing the dynamic picture;
a still picture displaying region for displaying the plurality of still pictures; and
a text information inputting region for the user to input the text information.

8. The web server as claimed in claim 7, wherein:
the still picture displaying region comprises a plurality of first rectangular regions, and each first rectangular region is used for displaying one still picture; and
the text information displaying region comprises a plurality of second rectangular regions, the second rectangular regions being used for displaying the text information corresponding to each still picture.

9. The web server as claimed in claim 8, wherein each first rectangular region and its corresponding second rectangular region are arranged next to each other, side by side.

10. The web server as claimed in claim 9, wherein when one of the still pictures is selected, the dynamic picture is played, the dynamic picture being played from the time stamp at which the selected still picture appears in the dynamic picture.

11. The web server as claimed in claim 10, wherein the memory stores the plurality of the dynamic picture databases established by different users, and the search for the keyword is executed among the plurality of dynamic picture databases established by different users.

12. The web server as claimed in claim 11, wherein the processor executing the software program to perform the steps further comprises the following step: providing a search interface for the user to input the keyword.

13. The web server as claimed in claim 12, wherein when the processor executing the software program to perform steps further comprises the following step: providing a search result interface to display a single or a plurality of still pictures corresponding to the keyword.

14. A method enabling a user to process a dynamic picture via a computer or a web server for searching purposes, the method comprising:
providing an operating interface, the operating interface comprising:
a dynamic picture playing region for playing the dynamic picture;
a still picture displaying region for displaying a plurality of still pictures, wherein the plurality of still pictures is extracted from the dynamic picture; and
a text information input region enabling the user to input text information, wherein the text information corresponds to one of the plurality of still pictures; and
providing a search result interface for the user to input at least one keyword.

15. The method as claimed in claim 14, wherein:
the still picture displaying region comprises a plurality of first rectangular regions, and each first rectangular region displays one still picture; and
the text information displaying region comprises a plurality of second rectangular regions, and each second rectangular region displays corresponding text information for each still picture.

16. The method as claimed in claim 15, wherein each first rectangular region and its corresponding second rectangular region are arranged next to each other, side by side.

17. The method as claimed in claim 16, wherein when one of the still pictures is selected, the dynamic picture is played, the dynamic picture being played from the time stamp at which the selected still picture appears in the dynamic picture.
